(19) United States
(12) Patent Application Publication
(10) Pub. No.: US 2016/0195425 A1
(43) Pub. Date: Jul. 7, 2016

(54) ONLINE MASS ESTIMATION

(71) Applicant: DANA LIMITED, Maumee, OH (US)

(72) Inventors: MARK R.J. VERSTEYHE, OOSTKAMP (BE); MARK M.A. MAESSEN, ROERMOND (NL); STIJN GOOSSENS, ERPE-MERE (BE)

(73) Assignee: DANA LIMITED, MAUMEE, OH (US)

(21) Appl. No.: 14/392,376

(22) PCT Filed: Sep. 9, 2014
(86) PCT No.: PCT/US2014/054719

§ 371 Date: Mar. 3, 2016

Related U.S. Application Data
(60) Provisional application No. 61/875,163, filed on Sep. 9, 2013.

(51) Int. Cl. G01G 19/08

(52) U.S. Cl. CPC G01G 19/086

(57) ABSTRACT

A method for estimating a total mass of a vehicle is provided. The method comprises the steps of providing a plurality of speed sensors configured to sense a rotational speed of a plurality of components of a driveline of the vehicle, estimating an output torque of the driveline of the vehicle, calculating gear losses based on the output torque of the driveline, estimating friction losses based on a rotational speed of a torque converter, calculating a rolling resistance of the vehicle, calculating an inertia of the vehicle, and estimating the total mass of the vehicle based on the inertia of the vehicle. The method uses currently available sensors found in a vehicle transmission to estimate a total mass of a vehicle or a vehicle payload.

### RELATED APPLICATION

The present application claims the benefit of U.S. Provisional Application No. 61/875,163 filed on Sep. 9, 2013, which is incorporated herein in its entirety by reference.

### FIELD OF THE INVENTION

The invention relates to control of vehicle systems and, more particularly, to method for estimating a total mass of a vehicle or a vehicle payload.

### BACKGROUND OF THE INVENTION

Currently, production shift controllers do not perform vehicle mass estimation. Settings used in prior art shift controllers are determined by weighing considerations between shift performance and robustness for the expected mass fluctuations. However, before shifting, prior art shift controllers may derive a current load using information from a torque converter working point, which is used as an input for the shift controller, and adapting the feed forward shifting profiles. Communication with telematics systems have not been implemented in prior art shift controllers.

It would be advantageous to develop a method for estimating a total mass of a vehicle or a vehicle payload by using currently available sensors found in a vehicle transmission.

### SUMMARY OF THE INVENTION

Presently provided by the invention, a method for estimating a total mass of a vehicle or a vehicle payload by using currently available sensors found in a vehicle transmission, has surprisingly been discovered.

In one embodiment, the present invention is directed to a method for estimating a total mass of a vehicle is provided. The method comprises the steps of providing a plurality of speed sensors configured to sense a rotational speed of a plurality of components of a driveline of the vehicle, estimating an output torque of the driveline of the vehicle, calculating gear losses based on the output torque of the driveline, estimating friction losses based on a rotational speed of a torque converter, calculating a rolling resistance of the vehicle, calculating an inertia of the vehicle, and estimating the total mass of the vehicle based on the inertia of the vehicle.

In another embodiment, the present invention is directed to a method for estimating a total mass of a vehicle. The method comprises the steps of providing a plurality of speed sensors configured to sense a rotational speed of a plurality of components of a driveline of the vehicle, estimating an output torque of the driveline of the vehicle using a rotational speed of a power source of the vehicle, a rotational speed of a portion of the torque converter, and at least one lookup table, calculating gear losses based on the output torque of the driveline, a gear mesh efficiency, and a number of gear meshes, estimating friction losses based on a rotational speed of a torque converter, calculating a rolling resistance of the vehicle as a function of the total mass of the vehicle, the gravity constant, and a rolling friction, calculating an inertia of the vehicle, calculating an acceleration of the vehicle by deriving an output speed of the driveline, estimating the total mass of the vehicle based on the inertia of the vehicle, and using at least one of an estimator and a state observer to improve the estimation of the total mass of the vehicle.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic illustration of a vehicle driveline including an online mass estimation system according to the present invention;

FIG. 2 is an exemplary graph plotting an estimated payload of a vehicle versus time;

FIG. 3 is a schematic illustration of a Kalman filter, which may form a portion of the online mass estimation system illustrated in FIG. 1; and

FIG. 4 is an exemplary graph plotting a propagated state estimate and an actual state trajectory versus time.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise.

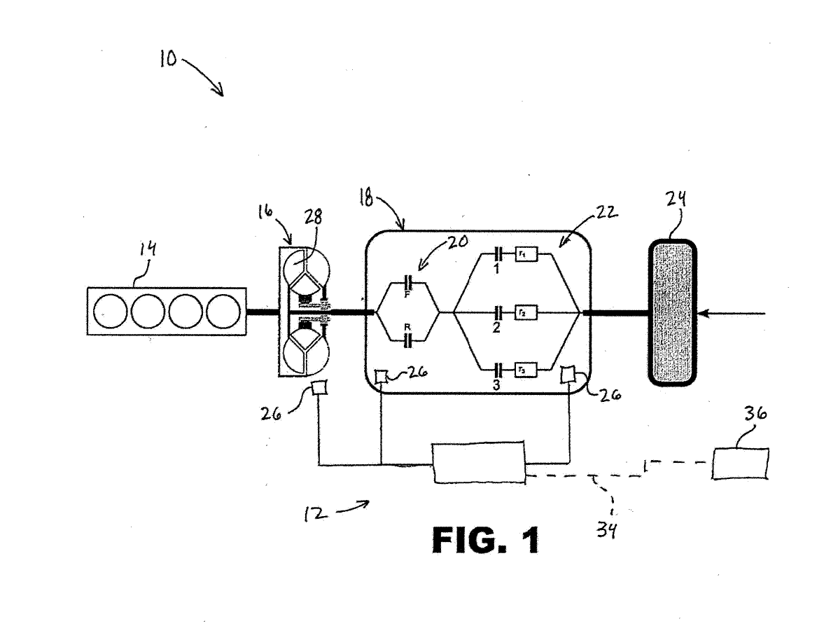

FIG. 1 shows an exemplary driveline 10 for a vehicle (not shown) incorporating an online mass estimation system 12. The online mass estimation system 12 is able to determine information about a total mass of the vehicle or a payload transported by the vehicle. A power source 14, which may be an internal combustion engine, for example, applies a rotational force to a torque converter 16. The rotational force, or input torque, applied to the torque converter 16 results in an output torque (Tₜᵤᵣ), which is used to drive a transmission 18. The transmission 18 includes a direction selector 20 and a range clutch arrangement 22. The direction selector 20 is used to place the transmission 18 in one of a forward operating condition and a reverse operating condition. The range clutch arrangement 22 shown includes three drive ratios, which are chosen based on an operating need of the vehicle. It is understood that the range clutch arrangement 22 may include another number of drive ratios. A rotational inertia 24 (J_{veh,eq}) of the vehicle, which exhibits a similar dynamic behavior to a remaining portion of the driveline 10 of the vehicle, is represented schematically in FIG. 1.

A behavior of the driveline 10 may be described by the following equation:

$$\frac{{T}_{tur} - {T}_{gear loss} - {T}_{friction loss}}{{r}_{1 , 2 , 3}} = {J}_{veh , eq} {\dot{ω}}_{out} + {T}_{roll} + {T}_{drag}$$

A loss of torque within the transmission due to gearing and friction are respectively indicated as T_{gear loss} and T_{friction loss}.

By combining information from a plurality of speed sensors 26 in the transmission 18 with some additional parameters it is possible to estimate a total inertia of the vehicle, and thus a total mass of the vehicle. The plurality of speed sensors 26 are configured to sense a rotational speed of a plurality of components of the driveline 10. The output torque (Tₜᵤᵣ) is estimated using at least one lookup table using a rotation speed of the power source 14 speed and a rotational speed of a turbine portion 28 of the torque converter 16 (nₑ, nₜᵤᵣ) as inputs for the lookup table.

Tₜᵤᵣ=f(nₑ,nₜᵤᵣ)

The gear losses are a function of the output torque (Tₜᵤᵣ), a gear mesh efficiency (η) and a number of gear meshes (n).

T_{gear loss}=Tₜᵤᵣ(1−ηⁿ)

The friction losses are estimated using a function based on a rotational speed of a turbine portion 28 of the torque converter 16 (nₜᵤᵣ).

T_{friction loss}=f(nₜᵤᵣ)

An equivalent vehicle inertia is computed from the total mass of the vehicle (mᵥₑₕ, which is estimated) and a radius of each of the wheels (r_{w}).

Jᵥₑₕ=mᵥₑₕr_{w}²

A vehicle acceleration is derived from a derivative of an output speed (\dot{ω}ₒᵤₜ).

$${\dot{ω}}_{out} = \frac{d ( \frac{2 π \cdot {n}_{out}}{60} )}{d t}$$

A rolling resistance (Tᵣₒₗₗ) is a function of the total mass of the vehicle (mᵥₑₕ), the gravity constant (g) and a rolling friction (Cᵣₒₗₗ).

$${T}_{roll} = {m }_{veh} \cdot g \cdot {c}_{roll} = \frac{{J}_{veh}}{{r}_{w}^{2}} \cdot g \cdot {c}_{roll}$$

The drag loss (T_{drag}) is a function of a speed of the vehicle and a frontal area of the vehicle (which considers air density and a drag coefficient, as well). As the speeds of the vehicle the online mass estimation system 12 is most typically used with are typically low, the effects of drag from air may be considered a negligible influence and thus can be estimated as being substantially equal to zero.

T_{drag≈}0

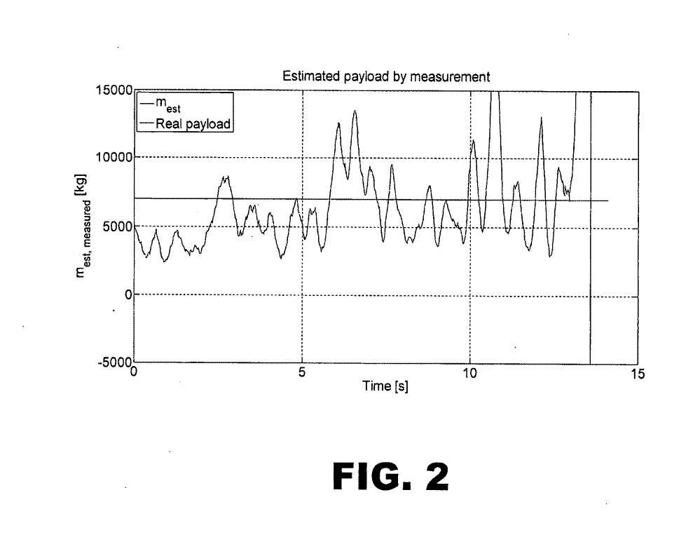

A mass estimation example performed by the online mass estimation system 12 using the method described above is shown in FIG. 2. Using only discrete measurements for the mass estimation typically results in an inaccurate mass estimation. While a mean estimate is better, the mean estimate may still be relatively inaccurate. The signal shown in FIG. 2 has large variations, which is typical for the signal generated by the online mass estimation system 12.

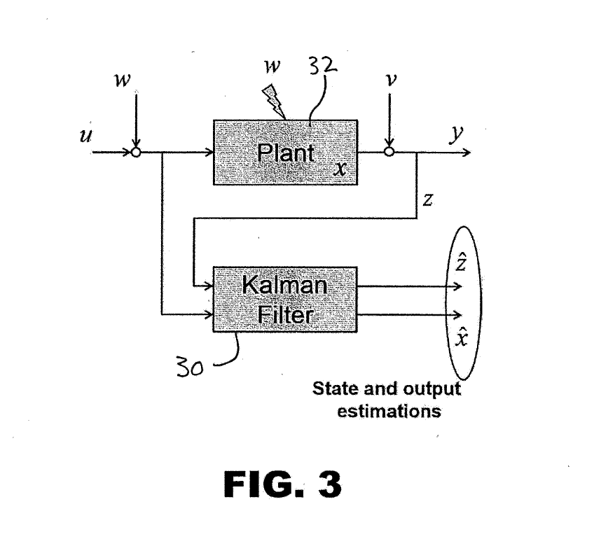

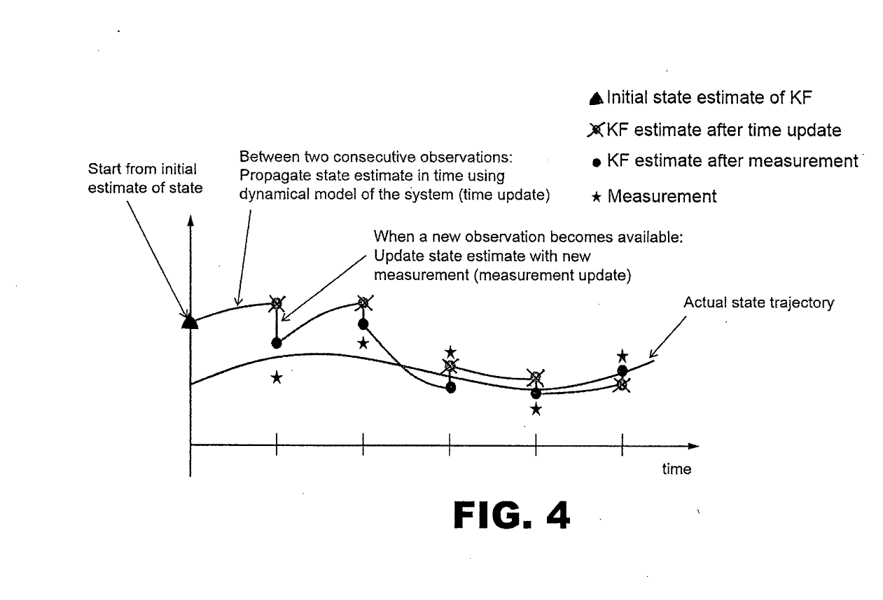

Introducing an estimator and/or a state observer can improve the mass estimation of the online mass estimation system 12 significantly. FIG. 3 shows a possible solution which makes use of a Kalman filter 30. The Kalman filter 30 uses the inputs to a plant 32 (which in this case, is the driveline 10) and, based on a model of the driveline 10, the online mass estimation system 12 computes a state of the driveline 10 in the near future. The measurements and computed states are combined with weighting factors to produce a more reliable output. The latest estimate, as described hereinabove, may be used as a start point for the model of the driveline 10. An example of an output of the online mass estimation system 12 including the Kalman filter 30 is shown in FIG. 4. As mentioned above, the use of the Kalman filter 30 requires the model of the driveline 10 to be present. To estimate the total mass of the vehicle, the same formulas used for the total mass estimation measurement can also be used for the model of the driveline 10. The difference is, besides the input torque, an estimated acceleration (in a very near future of operation) is used instead of the vehicle acceleration that is measured. With the current states, the total torque losses are then computed. This process provides a total mass estimation based on the model of the driveline 10. The total mass estimation may show a noisy behavior as well, and is sensitive to drifting due to errors in the model of the driveline 10. By combining the total mass estimation and the model of the driveline 10 with a tuned weighting factor, a more reliable final total mass estimation is possible. To prevent the model of the driveline 10 from drifting, a most recent total mass estimation is used as a start point for the next estimate of the model of the driveline 10.

Using state observers, in whatever form, is one of the possibilities to have an accurate total mass estimate for the vehicle or a payload transported by the vehicle.

The scope of the invention also includes supplementary methods to estimate a mass of the payload transported by the vehicle. Each of the supplementary methods requires the use of at least one additional sensor which, depending on the application, may or may not be practical to include.

Each of the supplementary methods to estimate a mass of the payload transported by the vehicle is detailed below.
A first supplementary method includes installing at least one strain gauge in a lifting device forming a portion of the vehicle. Techniques similar to those that are described above could be incorporated into the online mass estimation system 12 to increase reliability, such as reducing an effect of oscillations, gauge drift over time, and temperature sensitivity.
A second supplementary method includes installing a pressure sensor in a lifting device forming a portion of the vehicle including the online mass estimation system 12, where the lifting device is a hydraulic lifting device. A pressure required to lift or hold the payload can be used to determine a mass of the payload.

To improve a quality of the payload mass estimation using one of the above described supplementary methods, an additional acceleration sensor may be installed and in communication with the online mass estimation system 12. An improved accuracy of the acceleration of the vehicle can also be used to improve the total mass estimation.

The method described above and the vehicle incorporating the online mass estimation system 12 makes it possible to perform a total mass estimation of the vehicle without a need for increasing a number and type of sensors in the transmission 18. Without requiring additional sensors, the method and the vehicle incorporating the online mass estimation system 12 provides a large amount of freedom to use the method in varying situations and in different applications without requiring adjustments. Accordingly, through use of method and the vehicle incorporating the online mass estimation system 12, functionality is added to existing vehicles including similar transmissions.

The estimated total mass of the vehicle obtained using the method and the online mass estimation system 12 can be used for several purposes. The online mass estimation system 12 may use the estimated total mass as an additional input to adapt a shift strategy (and thus a shift controller) and a plurality of actuator outputs to a current load, resulting in improved shifting performance of the vehicle. Further, the estimated total mass or payload of the vehicle may be useful to a vehicle controller as well. The estimated total mass or payload of the vehicle could be used to enhance functionality of the vehicle controller through detection of an overload condition. In response to the overload condition, a vehicle stability system may be activated or enhances. The vehicle stability system may be used to prevent a high speed cornering of the vehicle based on the load, for example, in addition to triggering other safety related systems.

The estimated total mass or payload obtained using the method and the online mass estimation system 12 may be communicated through a wireless link 34 to one or more external device 36. The external device 36 may be used to perform additional processing on the estimated total mass and payload to further enhance functionality online mass estimation system 12 and the external device 36. As a non-limiting example, the estimated total mass may be used in a warehouse management software to track usage of the vehicle usage and a movement of a load performed by the vehicle. A bi-directional connection between the external device 36 and the vehicle incorporating the online mass estimation system 12 offers even further functionality. As non-limiting examples, the estimated total mass can be compared with an expected total mass to adjust the total estimated mass and to detect an incorrect pick-up of a load. The total expected mass and detection of the incorrect pick-up of the load can be provided as input data for an on-board diagnostics system of the vehicle.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A method for estimating a total mass of a vehicle, the method comprising the steps of:
providing a plurality of speed sensors configured to sense a rotational speed of a plurality of components of a driveline of the vehicle;
estimating an output torque of the driveline of the vehicle;
calculating gear losses based on the output torque of the driveline;
estimating friction losses based on a rotational speed of a torque converter;
calculating a rolling resistance of the vehicle;
calculating an inertia of the vehicle; and
estimating the total mass of the vehicle based on the inertia of the vehicle.

2. The method according to claim 1, further comprising the step of using at least one of an estimator and a state observer to improve the estimation of the total mass of the vehicle.

3. The method according to claim 2, wherein the step of using at least one of an estimator and a state observer to improve the estimation of the total mass of the vehicle is performed using a Kalman filter.

4. The method according to claim 2, wherein the step of using at least one of an estimator and a state observer to improve the estimation of the total mass of the vehicle is performed using a model of the driveline of the vehicle to calculate a future state of the driveline.

5. The method according to claim 4, wherein the estimation of the total mass of the vehicle, the model of the driveline of the vehicle, and a tuned weighting factor are combined to determine a final mass estimation.

6. The method according to claim 1, wherein the step of estimating an output torque of the driveline of the vehicle is performed using a rotational speed of a power source of the vehicle, a rotational speed of a portion of the torque converter, and at least one lookup table.

7. The method according to claim 1, wherein the step of calculating gear losses based on the output torque of the driveline is a function of a gear mesh efficiency and a number of gear meshes.

8. The method according to claim 1, wherein the step of calculating a rolling resistance of the vehicle is a function of the total mass of the vehicle, the gravity constant, and a rolling friction.

9. The method according to claim 1, further comprising the step of calculating an acceleration of the vehicle by deriving an output speed of the driveline.

10. The method according to claim 1, further comprising the step of providing a strain gauge installed in a lifting device forming a portion of the vehicle.

11. The method according to claim 1, further comprising the step of providing a pressure sensor in a hydraulic lifting device forming a portion of the vehicle.

12. The method according to claim 1, further comprising the step of providing an acceleration sensor to improve an accuracy of the total mass estimation.

13. The method according to claim 1, further comprising the step of using the total mass of the vehicle to adapt a shift strategy of the vehicle.

14. The method according to claim 1, further comprising the step of using the total mass of the vehicle to detect an overload condition of the vehicle.

15. The method according to claim 1, further comprising the step of providing the total mass of the vehicle to an external device through a wireless link.

16. A method for estimating a total mass of a vehicle, the method comprising the steps of:
providing a plurality of speed sensors configured to sense a rotational speed of a plurality of components of a driveline of the vehicle;
estimating an output torque of the driveline of the vehicle using a rotational speed of a power source of the vehicle, a rotational speed of a portion of the torque converter, and at least one lookup table;
calculating gear losses based on the output torque of the driveline, a gear mesh efficiency, and a number of gear meshes;
estimating friction losses based on a rotational speed of a torque converter;
calculating a rolling resistance of the vehicle as a function of the total mass of the vehicle, the gravity constant, and a rolling friction;
calculating an inertia of the vehicle;
calculating an acceleration of the vehicle by deriving an output speed of the driveline;
estimating the total mass of the vehicle based on the inertia of the vehicle; and
using at least one of an estimator and a state observer to improve the estimation of the total mass of the vehicle.

17. The method according to claim 16, wherein the step of using at least one of an estimator and a state observer to improve the estimation of the total mass of the vehicle is performed using a model of the driveline of the vehicle to calculate a future state of the driveline.

18. The method according to claim 17, wherein the estimation of the total mass of the vehicle, the model of the driveline of the vehicle, and a tuned weighting factor are combined to determine a final mass estimation.

19. The method according to claim 16, wherein the step of using at least one of an estimator and a state observer to improve the estimation of the total mass of the vehicle is performed using a Kalman filter.

20. The method according to claim 16, further comprising the step of using the total mass of the vehicle to adapt a shift strategy of the vehicle.
